(19) United States
(12) Patent Application Publication
(10) Pub. No.: US 2013/0247841 A1
(43) Pub. Date: Sep. 26, 2013

(54) Glow in the dark locator

(71) Applicants: Cheryl J. Stoffels, Wyoming, MN (US); Dennis L. Stoffels, Wyoming, MN (US)

(72) Inventors: Cheryl J. Stoffels, Wyoming, MN (US); Dennis L. Stoffels, Wyoming, MN (US)

(21) Appl. No.: 12/806,238

(22) Filed: Aug. 6, 2010

Related U.S. Application Data
(60) Provisional application No. 61/274,188, filed on Aug. 14, 2009.

(51) Int. Cl. A01K 27/00

(52) U.S. Cl. 119/858; 119/863

(57) ABSTRACT

A collar has an elongated strap attached to a buckle for releasably connecting the collar to a pet animal or human. A tubular plastic body with phosphorescent material located within the body is located around the strap. The phosphorescent material when subjected to natural or artificial light emits light in dark environments. A modification of the collar has a strip of light reflective material attached to a plastic body with phosphorescent material incorporated therein. The light reflective material has a prismatic shaped surface for reflecting light and radiating luminescent light emitted by the phosphorescent material. A buckle and loop are concurrently joined to the plastic body during the molding process of the plastic body.

### CROSS REFERENCE TO RELATED APPLICATION

This application claims the benefit of U.S. Provisional Patent Application Ser. No. 61/274,188 filed Aug. 14, 2009.

### FIELD OF THE INVENTION

This invention is related to visual location products that emit and reflect light which is perceived by humans. More particularly, the products are devices, including animal collars and human bands, that are visible at night and in dark environments.

### BACKGROUND OF THE INVENTION

Pets including dogs and cats have natural hue, brightness and color appearances that camouflage and blend in with their environment. They are difficult to see or find at night or in low light or poor visibility conditions. Pets when walked at night are difficult to see and can be injured by motor vehicles. Numerous devices have been developed to keep track of pets and hunting animals. Bells and radio tracking devices worn by the pets provide signals for tracking and locating the pets. Numerous persons have been treated for pet-related injuries, such as tripping over a pet in the dark. Bright colored clothing, LED lights and light phosphorescent collars are used to provide visual locations of pets.

Examples of devices for animals that are visible at night or in the dark are disclosed in the following U.S. patents.

E. Bozzacco in U.S. Pat. No. 4,407,233 discloses animal collars having flexible elements, strips or body portions having light reflective properties. Light reflective paints and coatings of fluorescent and phosphorescent materials are applied to the animal collars to facilitate location and safety of the animal at night. The collar includes a flexible strip molded from highly light-reflective plastic.

N. Schell in U.S. Pat. No. 5,169,702 discloses light reflective wraps used around the ankle, wrist and neck of humans or animals to identify the presence of such human or animal at night. The wrap comprises an elongated strip of elastic fabric with an elongated strip of reflective material superimposed on the fabric. Stitches join the fabric and reflective material. The reflective material is highly light-reflective fluorescent or phosphorescent.

A. B. Spencer and C. S. Ferguson in U.S. Pat. No. 5,237,448 describes a visibly enhanced material comprising a first layer of prismatic light reflective plastic material. A second layer of plastic luminescent material is contiguously and integrally attached to the first layer. The combined layers simultaneously reflect light and radiate luminescent light from the second layer and through the prismatic light reflective plastic material. The material is used as a leash for controlling and restraining a pet animal.

D. L. Longtin in U.S. Pat. No. 6,786,028 discloses safety and protective garments for animals, such as horses and dogs, having high visibility, illuminative and identification indicia. A series of illuminative strips or patches of fabrics are affixed with stitches or snap fasteners to garments for the animals.

M. Grogoza in U.S. Pat. No. 7,117,659 discloses animal restraint device in the form of a belt, strap or collar made of strong material, such as solid or woven manmade or natural substance. Luminescent dyes are infused into the material to afford a warning of the presence of the animal. The device has a breakaway feature that functions to disengage the collar ends when subjected to a predetermined force.

S. Morehead in U.S. Pat. No. 7,140,327 discloses a pet wearing collar. The collar includes a band with light-emitting elements, such as glass, plastic and stones. An illumination source mounted on the collar is connected to fiber optic strings. The fiber optic strings connected to the light-emitting elements transfers light to the light-emitting elements.

### SUMMARY OF THE INVENTION

The invention is an object, animal or person visual location or ornamental assembly having glow in the dark properties that emit light in dark environments and reflect light to provide safety of the animal and humans as well as ornamental enhancement. The visual location assembly has an elongated flexible strap connected to a buckle assembly for retaining the strap about the neck, arm or leg of an animal, such as a dog or cat, or a human. A sleeve with a passage for accommodating the strap has a tubular plastic body with phosphorescent material incorporated within the plastic body. The phosphorescent material is a powder of a group consisting of zinc sulfide, silicate aluminate and alkaline earth metal aluminate between 3 to 5 percent by volume of the plastic body. The phosphorescent material when exposed to natural or artificial light emits light in dark environments to provide a visual location of the assembly and object, animal or human. The plastic body in one embodiment of the invention includes a light reflecting strip having a prismatic shaped surface for reflecting light and radiating luminescent light emitted by the phosphorescent material. The plastic body in another embodiment is a transparent plastic member with phosphorescent material and light reflectors incorporated in the plastic. A buckle assembly and loop are concurrently joined by the molding process of the plastic body to the plastic body.

### DESCRIPTION OF DRAWING

FIG. 1 is an illustration of a canis familiwar, dog called Herbie, wearing that pet collar of the invention;

FIG. 2 is an enlarged foreshortened top plan view of the pet collar;

FIG. 3 is a foreshortened bottom plan view of FIG. 2;

FIG. 4 is a foreshortened side elevational view of FIG. 2;

FIG. 5 is an enlarged sectional view taken along the line 5-5 of FIG. 2;

FIG. 6 is an enlarged sectional view taken along the line 6-6 of FIG. 2;

FIG. 7 is an enlarged sectional vie taken along the line 7-7 of FIG. 2;

FIG. 8 is an enlarged sectional view taken along the line 8-8 of FIG. 2;

FIG. 9 is a foreshortened top plan view of the flow-in-the-dark sleeve of the pet collar of FIG. 2;

FIG. 10 is a foreshortened side elevation view of FIG. 9;

FIG. 11 is an end elevational view of right end of FIG. 2;

FIG. 12 is a sectional view taken along the line 12-12 of FIG. 9;

FIG. 13 is a foreshortened top plan view of a first modification of the pet collar of the invention;

FIG. 14 is a foreshortened bottom plan view of FIG. 13;

FIG. 15 is a foreshortened side elevational view of FIG. 13;

FIG. 16 is an enlarged sectional view taken along the line 16-16 of FIG. 13;

FIG. 17 is an enlarged sectional view taken along the line 17-17 of FIG. 13;

FIG. 18 is an enlarged sectional view taken along the line 18-18 of FIG. 13;

FIG. 19 is an enlarged sectional view taken along the line 19-19 of FIG. 2;

FIG. 20 is a foreshortened top plan view of a second modification of the pet collar of the invention;

FIG. 21 is a foreshortened bottom plan view of FIG. 20;

FIG. 22 is a foreshortened side elevational view of FIG. 20;

FIG. 23 is an enlarged sectional view taken along the line 23-23 of FIG. 20;

FIG. 24 is an enlarged sectional view taken along the line 24-24 of FIG. 20;

FIG. 25 is an enlarged sectional view taken along the lien 25-25 of FIG. 20;

FIG. 26 is an enlarged sectional view taken along the lien 26-26 of FIG. 20;

FIG. 27 is a foreshortened top plan view of a third modification of the pet collar of the invention;

FIG. 28 is a foreshortened bottom plan view of FIG. 27;

FIG. 29 is a foreshortened side elevational view of FIG. 27;

FIG. 30 is an enlarged sectional view taken along line 30-30 of FIG. 27;

FIG. 31 is an enlarged sectional view taken along line 31-31 of FIG. 27;

FIG. 32 is an enlarged sectional view taken along line 32-32 of FIG. 27;

FIG. 33 is an enlarged sectional view taken along line 33-33 of FIG. 27; and

FIGS. 34 to 37 correspond to FIGS. 30 to 33 with the strap containing phosphorescent materials and light reflective lenses.

### DESCRIPTION OF THE INVENTION

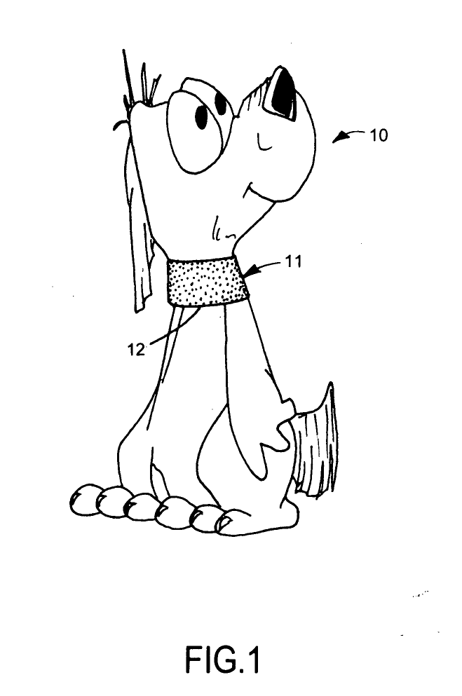

A domesticated animal 10, shown in FIG. 1 as a canis familiwar or dog named Herbie, has a pet collar 11 located around its neck 12. Collar 11 has a sleeve 27 containing light emitting and reflecting materials visible at night. Collar 11 is a circuitous band, belt, and halter worn by animals and humans to provide night visibility to facilitate location and safety and ornamental enhancement. The collars herein described are applicable for use by humans, and animals, including but limited to dogs, cats, horses, ferrets, and camels.

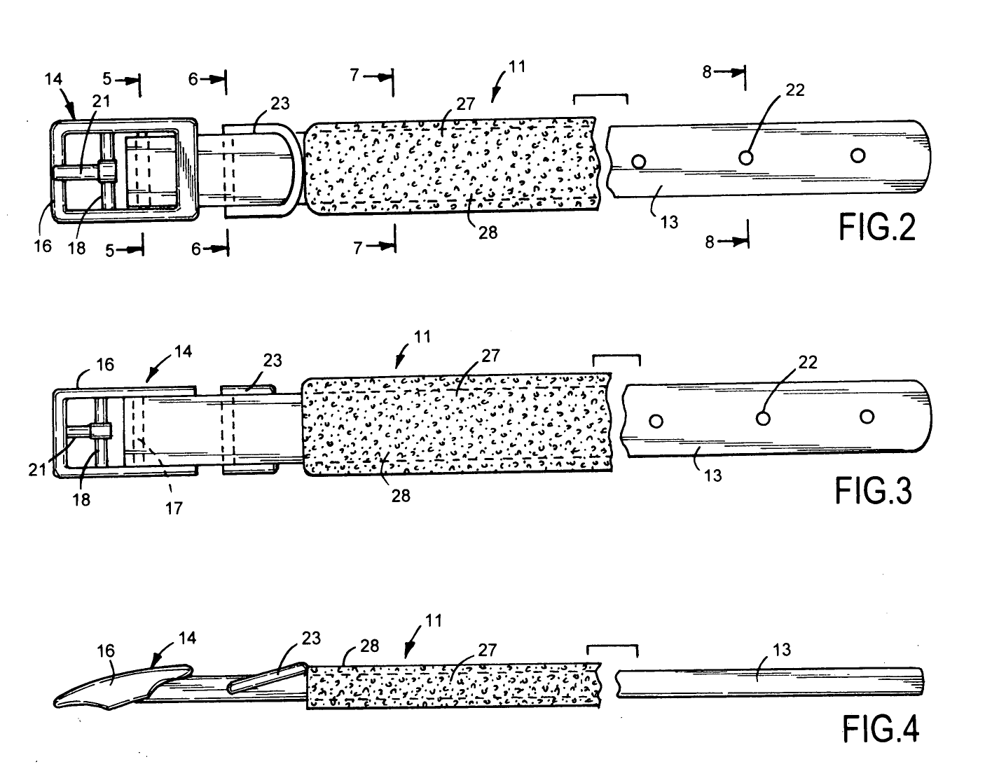

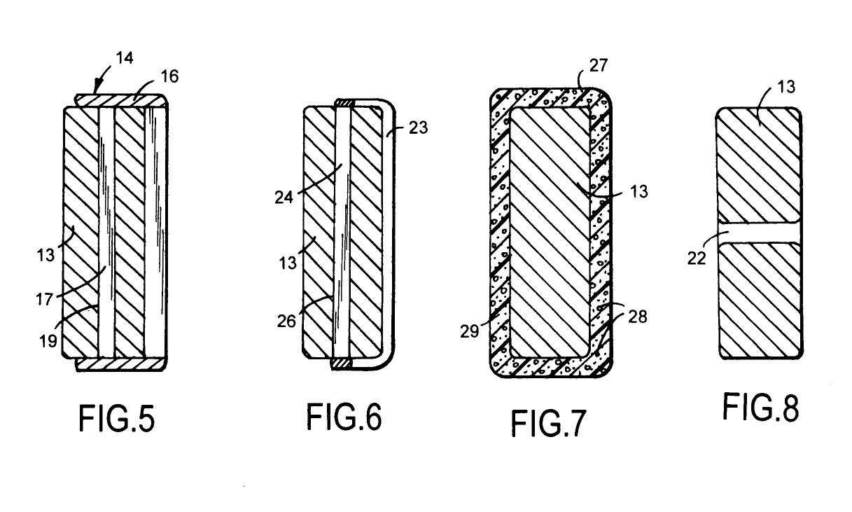

Collar 11, shown in FIGS. 2 to 4, comprises an elongated flexible strap 13 that is made of a strong material, such as leather, solid or woven manmade fibers or natural materials. A coupling member or buckle assembly 14 pivotally connected to a first end of strap 13 has a generally rectangular frame 16 supporting transverse rods 17 and 18. As shown in FIG. 5, rod 17 extends through a transverse hold 19 in strap 13 to secure strap 13 to buckle assembly 14. A longitudinal prong or finger 21 pivotally mounted on rod 18 extends over the outer portion of frame 16. Other types of coupling members can be used to connect the ends of strap 13. The second end of strap 13 has a plurality of holes 22 that extend through the width of strap 13 as shown in FIG. 8. A loop 23 pivotally mounted on strap 13 adjacent buckle assembly 14 holds the second end of strap 13 in an overlap relation with the first end of strap 13 when it is connected with prong 21 to buckle assembly 14. Loop 23 includes a transverse rod 24 extended through a transverse hole 26 in strap 13 as shown in FIG. 6. An example of strap 13 and buckle assembly 14 are an elongated fabric or leather body having a length of 16 inches, a width of 1 inch and thickness of ½ inch connected to a metal buckle assembly 14.

Returning to FIGS. 2 to 4 and 7, a tubular one-piece sleeve 27 is located around a linear section of strap 13 between loop 23 and the second end of strap 13 containing holes 22. Sleeve 27 can cover the second end of strap 13. Sleeve 27 is a flexible soft plastic, such as polyvinyl chloride or polyethylene, having inside surfaces that conform to the shape of the outside surfaces of strap 13 as shown in FIG. 7. A plurality of particles 28 of phosphorescent material are incorporated within the plastic of strap 13. The phosphorescent material emits light following exposure to and removal of incident radiation. The phosphorescent material is a powder of zinc sulfide, silicate aluminate, alkaline earth metal aluminate and like materials that emit light in dark environments. Examples of luminescence materials are disclosed by P. Burnett-Jones in U.S. Pat. No. 6,599,444 incorporated herein by reference. The term phosphorescent material in this disclosure is intended to include any material or composition which has phosphorescent, fluorescent and/or auto luminescent properties.

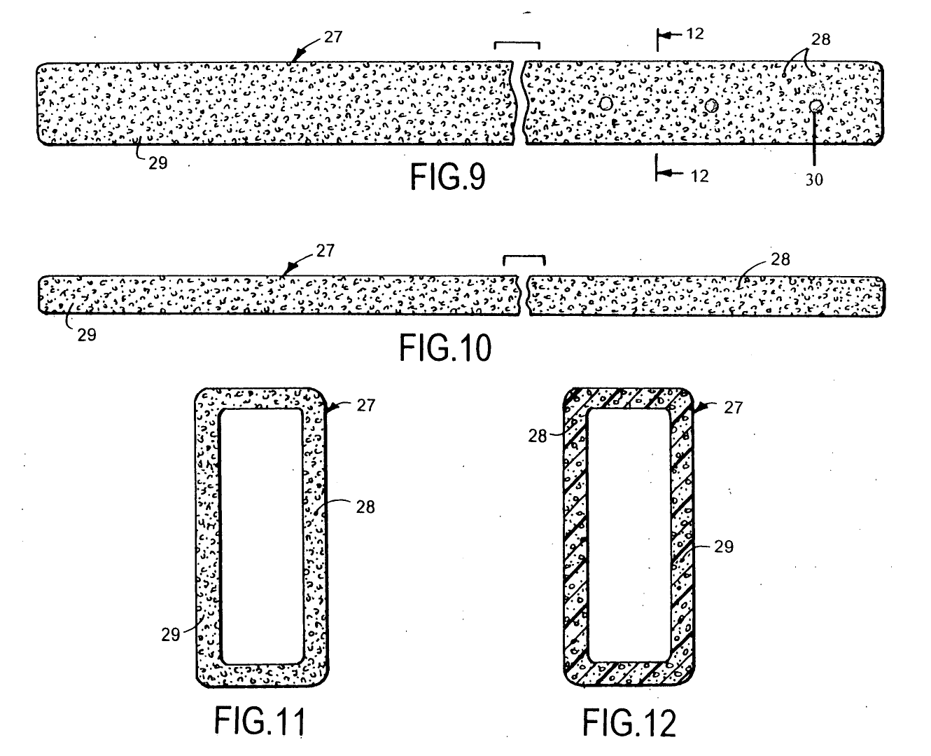

Sleeve 27, shown in FIGS. 8 to 12, is a mixture of a one-piece or continuous tubular transparent plastic body 29 with phosphorescent material comprising particles 28 uniformly distributed within the plastic body. The phosphorescent particles are powders that comprise between 3 to 5 percent of the material of volume of plastic body 29. Other amounts of phosphorescent particles can be incorporated in plastic body 29. The shape, size, number, and length of sleeve 27 can vary to accommodate different types, sizes and lengths of conventional collars and bands. In use, sleeve 27 is slipped over the free end of strap 13 to locate sleeve on strap 13. Sleeve 27 can be removed from strap 27 and replaced with a new sleeve which may have different light emitting color. Exposure to a light source, either natural or artificial, will recharge the phosphorescent material which emits visible light over an extended period of time. The recharging process can be achieved without removing the collar or sleeve from the animal or human. The materials of the strap 13 and sleeve 27 are biocompatible with the animals body skin and fur.

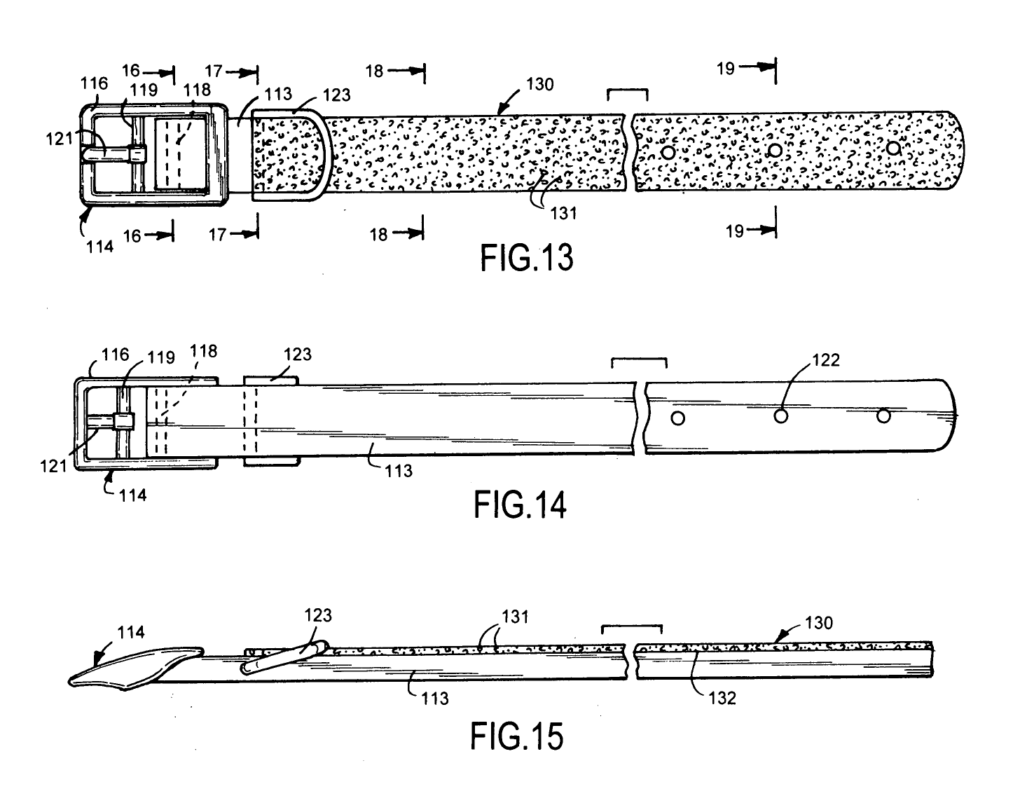

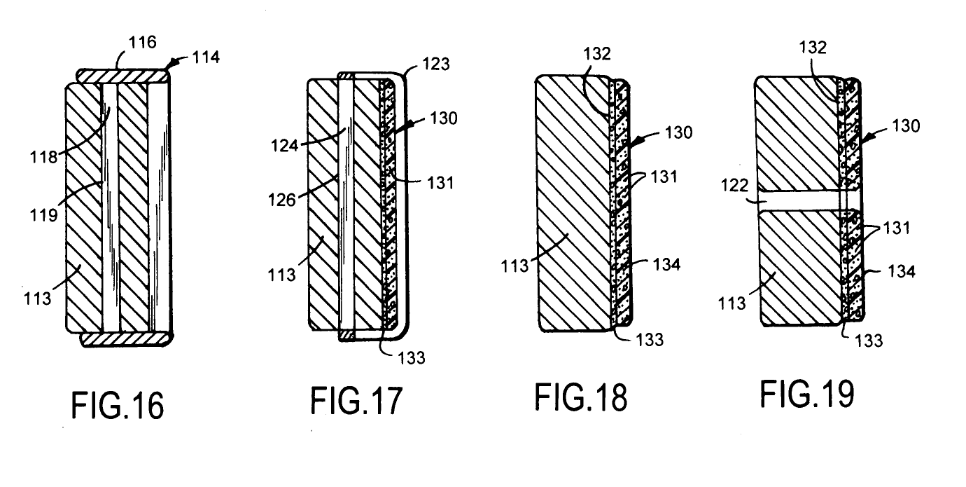

A first modification of the collar 111 of the invention shown in FIGS. 13 to 19 has a strap 113 attached to a buckle assembly 114. The parts of strap 113 and buckle assembly 114 that correspond to the parts of strap 13 and buckle assembly 14 have the same reference numbers with the prefix 1 as described herein. An elongated band 130 having light emitting material, shown as particles 131 is attached to the top surface 132 of strap 113. Bonding material or an adhesive layer 133 attaches band 130 to strap 113. Other types of fasteners, such as hook and loop connectors, stitches or snap devices can be used to releasably attach band to strap 113. Band 130 has a continuous plastic body 134 with phosphorescent material incorporated therein. Body 134 is a polyethylene with 3 to 5 percent by volume phosphorescent material. Other amounts of phosphorescent material can be incorporated in that plastic body 134. The types of phosphorescent material and powders are the same as phosphorescent material 28 as described herein. Alternatively, the body can be a polyester transfer of film or fabric having light reflecting and light emitting materials. Light reflectors can be incorporated in plastic body 134 to reflect light rays impinged thereon.

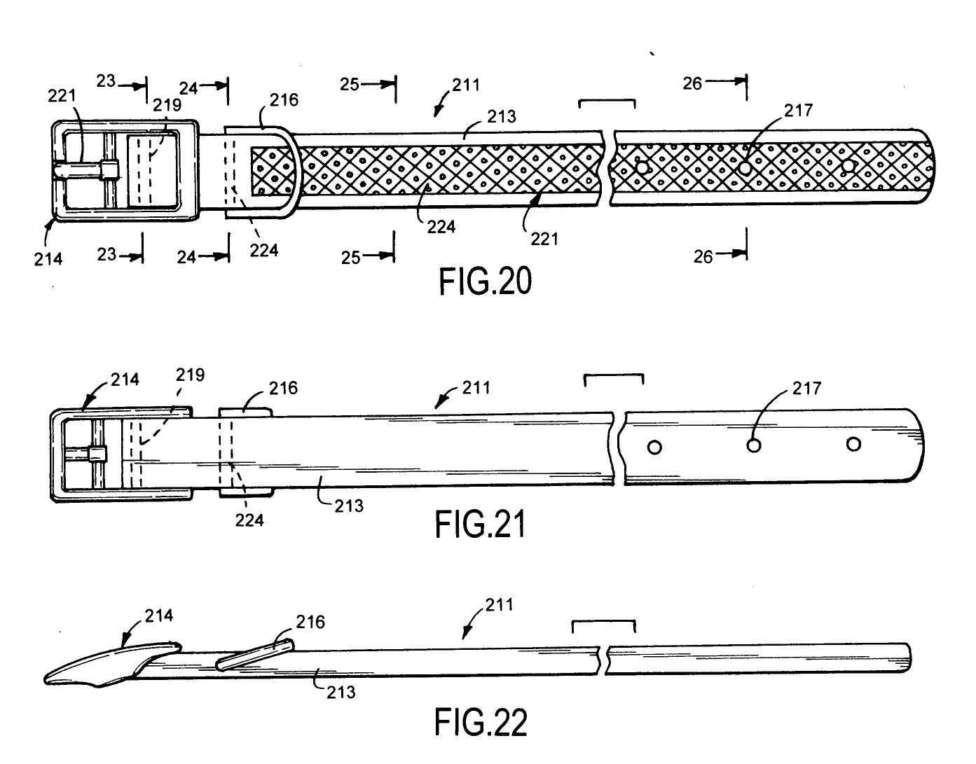

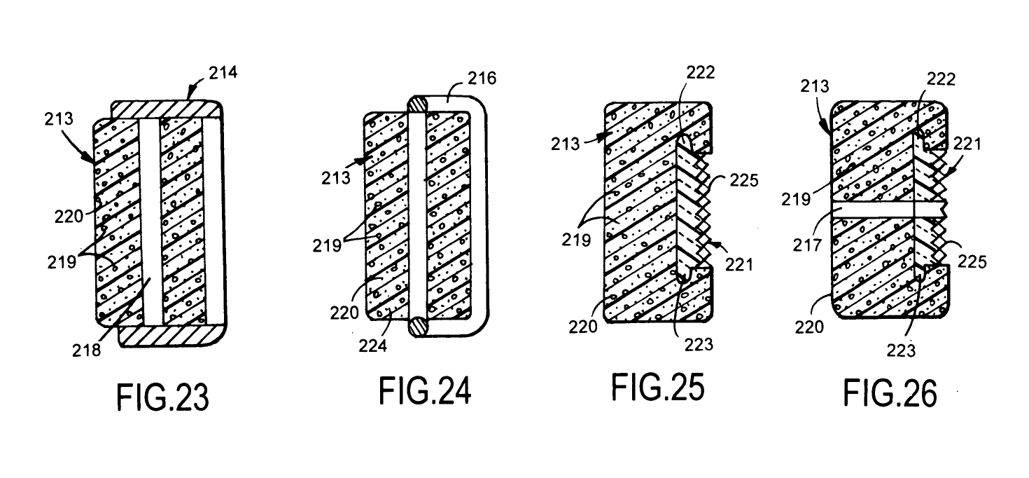

A second modification of the collar 211 of the invention is shown in FIGS. 20 to 26. Collar 211 has an elongated flexible plastic strap 213 attached at one end thereof to a coupling member or buckle assembly 214 as shown in FIG. 23. Buckle assembly 214 has the same parts as buckle assembly 14 with corresponding parts having the same reference members with the prefix 2. Other types of coupling devices can be secured to strap 213. A loop 216 connected to strap 213 adjacent buckle assembly 214 accommodates the free end of strap 213 and holds the free end of strap 213 in an overlap relation with the buckle end of strap 213 when it is attached to buckle assembly 214. As shown in FIG. 24, loop 216 is pivotally connected to strap 213. The plastic body, as shown in FIGS. 23 and 24, is molded around rod 218 of buckle assembly 214 and rod 224 of loop 216 during the molding process of the plastic body 220. Strap 213 is an elongated flexible plastic body 220 having light emitting particles or powders incorporated therein. Body is a polyvinyl chloride or polyethylene plastic with 3 to 5 percent by volume of phosphorescent particles 219 uniformly dispersed therein. The phosphorescent particles are the same as the phosphorescent materials 28 described herein.

As shown in FIGS. 20, 25 and 26, an elongated strip 221 of light reflective material is molded in body 220. Strip 221 has lateral linear flanges or ribs 222 and 223 located in grooves in body 220 to retain strip 221 on body 218. Strip 221 can have a dove tail shape to secure it to body 220. The outer side of strip 221 has a prismatic shaped surface 224 for reflecting rays of light. Strip 221 is a transparent or semi-transparent glass or synthetic plastic material that radiates luminescent light emitted by phosphorescent particles 219 dispensed in body 220. Strip 221 includes a retroreflective material that reflects the bulk of the light rays impinged thereon in a substantially parallel path back toward the source of the light. An example of this material is disclosed by Rowland in U.S. Pat. No. 3,684,348. The strip 221 can also be attached to the tubular plastic body of sleeve 27.

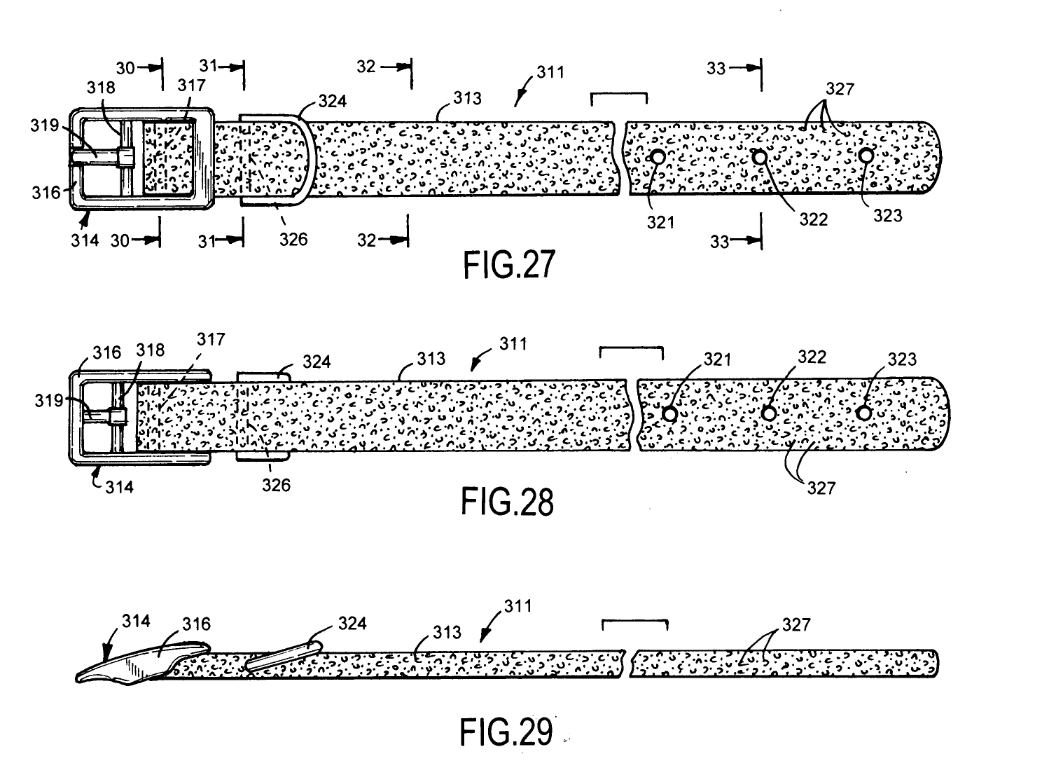

A third modification of collar 311 of the invention, shown in FIGS. 27 to 33, has an elongated flexible plastic strap 313. Strap 313 is a one-piece molded body of polymerized thermoplastic vinyls, such as polyvinyl chloride. Other plastic including polymerized ethylene resin, such as polyethylene, can be used to mold the one-piece body of strap 313. A plurality of particles or powder 327 of phosphorescent material is incorporated within the plastic of strap 313. The parties 327 of phosphorescent material are uniformly distributed in the plastic so that the entire strap 313 emits light at night or in dark environments. The phosphorescent material 327 is the same as phosphorescent material 28 described herein. Examples of luminescence materials are disclosed by P. Burnett-Jones in U.S. Pat. No. 6,599,444 incorporated herein by reference. The phosphorescent particles comprise between 3 to 5 percent of the volume of the plastic body of strap 313. Other amounts of phosphorescent material can be incorporated in the plastic body. The shape, size, width and length of strap 313 can vary to accommodate different animals and uses. Exposure to a light source, either natural or artificial, will recharge the phosphorescent material which emits visible light over an extended period of time. The recharging process can be achieved without removing collar 311 from the animal or human. Strap 313 and phosphorescent material therein are biocompatible with the animal's body, skin and fur.

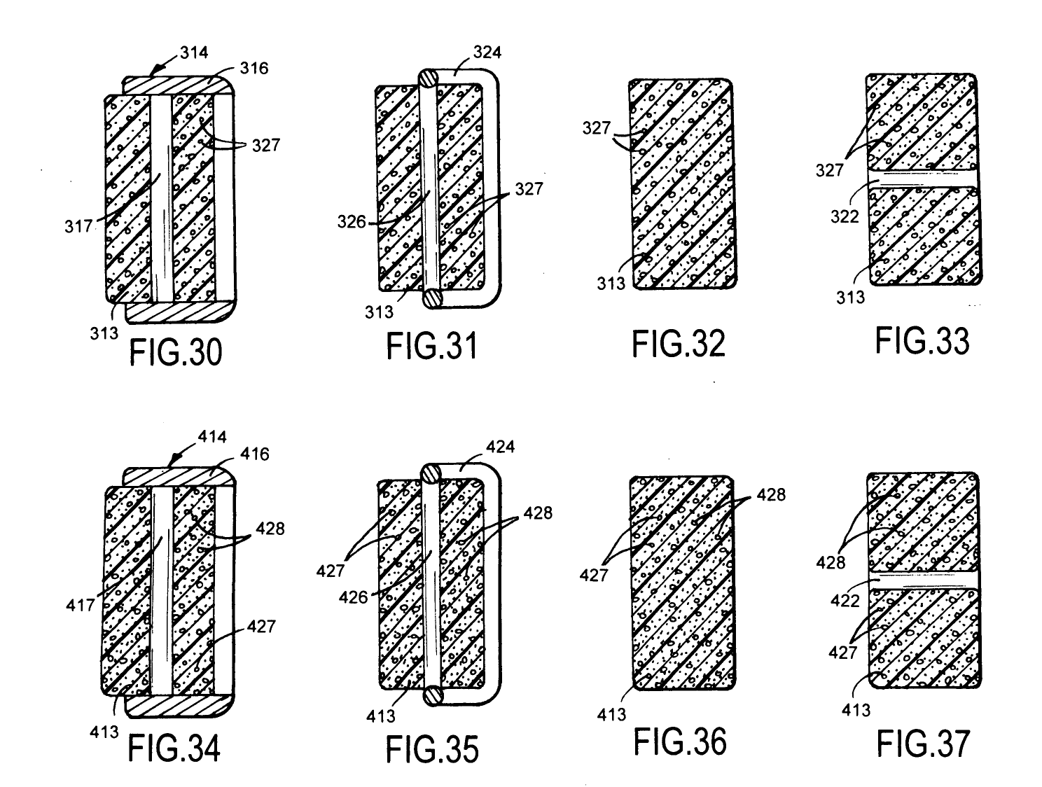

A buckle assembly 314 pivotally connected to a first end of strap 313 has a generally rectangular frame 316 joined to transverse rods 317 and 318. Frame 316 and rods 317 and 318 are a one-piece metal member having parallel sides and transverse ends. Rods 317 and 318 are joined to the sides of frame 316. The plastic body at the first end of strap 313 is molded around rod 317, as shown in FIG. 30, during the molding of strap 313. Separate fasteners, such as rivets, are not used to secure strap to rod 317. A longitudinal prong or finger 319 pivotally mounted on rod 318 has an outer end extended over an outer transverse end of frame 16. Prong 319 is adapted to extend through one of holes 321, 322 and 323, shown in FIGS. 27, 28 and 33, in the second end portion of strap 313.

A loop 324 pivotally mounted on strap 313 adjacent buckle assembly 314 holds the second end of strap 313 in an overlap relation with the first end of strap 313 when prong 319 is connected to the second end of the strap. Loop 324 has a generally U-shaped member and a transverse rod 326. Loop 324 is a one-piece metal D-shaped ring or member. Rod 326 extends transversely through the plastic body of strap 313. As shown in FIG. 31, the plastic body of strap 313 is molded around rod 326 during the molding of strap 313. The buckle assembly 314 and loop 324 are concurrently joined by the molding process of the plastic body to the plastic body. An injection molding process is used to connect buckle assembly 314 and loop 324 to the plastic body of strap 313.

The strap 413, buckle assembly 414 and loop 424, shown in FIGS. 34 to 37, have the same structure and process of molding the buckle assembly 414 and loop 424 as shown and described with reference to FIGS. 23 to 33. The parts of strap 413, buckle assembly 414 and loop 424 have the same reference numbers with the prefix 4. The plastic body of strap 413 in addition to particles of phosphorescent material 427 has a plurality of light reflective lenses distributed throughout the plastic body. Other types of retroreflective materials capable of reflecting light rays impinged thereon can be incorporated into the plastic body of strap 413. Examples of these materials are cube corner reflectors molded from glass or acrylic resins. Rowland in U.S. Pat. No. 3,684,348 discloses a retroreflective composite synthetic plastic material having cube corner formations that can be incorporated in the plastic body of strap 413.

The preferred embodiments of the invention have been disclosed and illustrated in the drawing. It is understood by persons skilled in the art that various other modifications and materials may be made without departing form the scope of the invention.

1. A visual location assembly comprising:
an elongated strap comprising an elongated flexible flat member having a first end and a second end and outside surfaces,
a buckle assembly connected to the first end of the member,
said buckle assembly including a finger,
a plurality of holes in the member adjacent the second end thereof for accommodating the finger of the buckle assembly,
a loop connected to the member adjacent the buckle assembly for holding the second end of the member, and
a sleeve located around the member and extended from the loop toward the second end of the member,
said sleeve comprising a tubular plastic body having inside surfaces that conform to the shape of the outside surfaces of the member providing a chamber for the member,
said body comprising a polyvinyl chloride or polyethylene plastic generally flat tubular body,
said body having holes aligned with the holes in the member to accommodate the finger of the buckle assembly to retain the member and sleeve in a loop shape, and
a plurality of phosphorescent particles incorporated within the tubular plastic body and uniformly distributed within the tubular plastic body and comprising between 3 to 5 percent by volume of the tubular plastic body, said plurality of phosphorescent particles comprising a powder of a group consisting of zinc sulfate, silicate aluminate and alkaline earth metal aluminate, said phosphorescent particles when exposed to natural or artificial light emit visual light in dark environments thereby providing a human visual location of the assembly and object, animal, or person associated with the visual location assembly.

2-5. (canceled)

6. A visual location assembly comprising:
an elongated strap comprising an elongated flexible member having a first end and a second end and outside surfaces,
a coupling member connected to the first end of the member for releasably connecting the first and second ends of the member,
a sleeve located around the member,
said sleeve comprising a tubular plastic body having inside surfaces that conform to the shape of the outside surfaces of the member providing a chamber for the member, and
a plurality of phosphorescent particles incorporated within the tubular plastic body and uniformly distributed within the tubular plastic body and comprising between 3 to 5 percent by volume of the tubular plastic body, said phosphorescent particles comprising a group of glow-in-the dark materials consisting of zinc sulfide, silicate aluminate and alkaline earth metal aluminate, said phosphorescent particles when exposed to natural or artificial light emit visual light in dark environments thereby providing a human visual location of the assembly and object, animal or human associated with the visual location assembly.

7. (canceled)

8. The visual location assembly of claim 6 wherein:
the body is a tubular polyvinyl chloride or polyethylene member.

9. The visual location assembly of claim 6 wherein:
the body has a generally rectangular cross sectional shape.

10-35. (canceled)
